(19) United States
(12) Patent Application Publication
(10) Pub. No.: US 2024/0263034 A1
(43) Pub. Date: Aug. 8, 2024

(54) ACRYLIC RESIN WITH UREIDO FUNCTIONALITY

(71) Applicant: SWIMC LLC, Cleveland, OH (US)

(72) Inventor: Zhangqing Yu, Twinsburg, OH (US)

(21) Appl. No.: 18/426,452

(22) Filed: Jan. 30, 2024

Related U.S. Application Data
(60) Provisional application No. 63/482,638, filed on Feb. 1, 2023.

(51) Int. Cl. C09D 133/06; C08F 220/18

(52) U.S. Cl. CPC C09D 133/066; C08F 220/1811; C08F 2810/50

(57) ABSTRACT

The present application relates to an acrylic resin suitable for two-component polyurethane coating applications. Provided herein is an acrylic resin comprising at least one epoxy silane oligomer, wherein the epoxy silane oligomer is grafted onto at least one hydroxy group of the acrylic resin; wherein the at least one hydroxy group of the acrylic resin has at least one ureido functionality; and wherein the at least one hydroxy group of the acrylic resin has at least one acid group. A two-component coating system is also disclosed comprising the acrylic resin comprising at least one hydroxy group with at least one epoxy silane oligomer, wherein the at least one hydroxy group of the acrylic resin has at least one ureido functionality.

### FIELD

The present disclosure relates generally to compositions for a resin, and, more particularly, an acrylic resin comprising at least one epoxy silane oligomer, wherein the epoxy silane oligomer is grafted onto at least one hydroxy group of the acrylic resin; wherein the at least one hydroxy group of the acrylic resin has at least one ureido functionality; and wherein the at least one hydroxy group of the acrylic resin has at least one acid group. Further, a two-component coating system is also disclosed comprising the acrylic resin comprising at least one hydroxy group with at least one epoxy silane oligomer, wherein the at least one hydroxy group of at least one acrylic resin has at least one ureido functionality.

### BACKGROUND

Typically, conventional polyurethane primers may provide fast curing properties. However, urethane primers typically lack adequate adhesion in direct-to-metal (DTM) applications without an etching primer layer. The etching primer layer is an extra step in the coatings process and often undesirable. In order to improve adhesion in DTM applications, an epoxy primer may be used instead of a urethane primer, but it is slow to cure. Although certain properties may improve with changes to the polyurethane and the coatings formulation, others may suffer due to these modifications.

Manufacturers, especially wood, plastics, electronics, automotive, aerospace, marine, general industrial, and other consumer goods manufacturers, have increasingly demanded for these particular performance requirements for primers. Manufacturers are continually looking for coatings that exhibit these improved properties, such as adhesion and fast dry times, without sacrificing other performance properties. In view of these challenges with many conventional polyurethane primers, the need therefore remains for improved coatings having a binder that can provide adhesion, and other improved properties as well as other advantages. Additionally, there is also a need to provide improved coatings that substantially perform as well as epoxy primers.

### SUMMARY

The embodiments of what is described herein are not intended to be exhaustive or to limit what is provided in the claimed subject matter and disclosed in the detailed description. Rather, the embodiments are chosen and described so that others skilled in the art may appreciate and understand the principles and practices of what is provided in the claimed subject matter.

An acrylic resin and methods of preparing are shown and described. The acrylic resin may comprise at least one epoxy silane oligomer, wherein the epoxy silane oligomer is grafted onto at least one hydroxy group of the acrylic resin; wherein the at least one hydroxy group of the acrylic resin has at least one ureido functionality; and wherein the at least one hydroxy group of the acrylic resin has at least one acid group. In some embodiments, the Tg of the acrylic resin is between 10° C. and 90° C. as measured by Differential Scanning calorimetry (DSC) using ASTM D6604-00 In another embodiment, the ureido functionality comprises a ureido monomer with a (meth)acrylate group and a cyclic ureido group.

Further, a two-component coating system comprising: 1) a first part comprising at least one isocyanate; and 2) a second part comprising the acrylic resin described herein is also provided.

To the accomplishment of the foregoing and related ends, the following description set forth certain illustrative aspects and implementations. These are indicative of a few of the various ways in which one or more aspects may be employed. Other aspects, advantages and novel features of the disclosure will become apparent from the following detailed description when considered.

### DETAILED DESCRIPTION

Aspects of what is described herein are disclosed in the following description related to specific embodiments. Alternative embodiments may be devised without departing from the scope of what is described herein. Additionally, well-known embodiments of what is described herein may not be described in detail or will be omitted so as to not obscure the relevant details of what is described herein. Further, to facilitate an understanding of the description, discussion of several terms used herein follows.

As used herein, the word “exemplary” means “serving as an example, instance, or illustration.” The embodiments described herein are not limiting, but rather exemplary only. It should be understood that the described embodiments are not necessarily to be construed as preferred or advantageous over other embodiments. Moreover, the term “embodiment(s)” does not require that all embodiments include the discussed feature, advantage, or mode of operation.

The present disclosure relates generally to binders that provide advantageous improvements over current resins. It has been discovered that the use of a particular acrylic resin comprising at least one epoxy silane oligomer, wherein the epoxy silane oligomer is grafted onto at least one hydroxy group of the acrylic resin; wherein the at least one hydroxy group of the acrylic resin has at least one ureido functionality, and wherein the at least one hydroxy group of the acrylic resin has at least one acid group may provide improved adhesion and fast drying properties over conventional polyurethanes and epoxies. In some embodiments, the acrylic resin described herein may be used in a coating. In one embodiment, the coating may be a primer. In another embodiment, the coating may be a topcoat.

The milligrams of potassium hydroxide required to neutralize one gram of the solution is called the hydroxyl number (which can also be referred to as hydroxyl value), as discussed in ASTM D4274-11.2 This wet chemistry method is complicated, time consuming, and requires several reagents. More recently, Fourier transform near-infrared (FT-NIR) spectroscopy has been used to determine the hydroxyl value of various materials, per ASTM D6342-12. In many embodiments, the acrylic resin has a hydroxyl number of 50 to 250 mg KOH/g. In other embodiments, the acrylic resin described herein can have a hydroxyl number, for example, range from 50 to 240 mg KOH/g, from 50 to 230 mg KOH/g, from 50 to 220 mg KOH/g, from 50 to 210 mg KOH/g, from 50 to 200 mg KOH/g, from 50 to 190 mg KOH/g, from 50 to 180 mg KOH/g, from 50 to 170 mg KOH/g, from 50 to 150 mg KOH/g, from 50 to 140 mg KOH/g, from 50 to 130 mg KOH/g, from 50 to 110 mg KOH/g, from 50 to 100 mg KOH/g, from 60 to 250 mg KOH/g, from 60 to 240 mg KOH/g, from 60 to 230 mg KOH/g, from 60 to 220 mg KOH/g, from 60 to 210 mg KOH/g, from 60 to 200 mg KOH/g, from 60 to 190 mg KOH/g, from 60 to 180 mg KOH/g, from 60 to 170 mg KOH/g, from 60 to 150 mg KOH/g, from 60 to 140 mg KOH/g, from 60 to 130 mg KOH/g, from 60 to 110 mg KOH/g, from 60 to 100 mg KOH/g, from 70 to 250 mg KOH/g, from 70 to 240 mg KOH/g, from 70 to 230 mg KOH/g, from 70 to 220 mg KOH/g, from 70 to 210 mg KOH/g, from 70 to 200 mg KOH/g, from 70 to 190 mg KOH/g, from 70 to 180 mg KOH/g, from 70 to 170 mg KOH/g, from 70 to 150 mg KOH/g, from 70 to 140 mg KOH/g, from 70 to 130 mg KOH/g, from 70 to 110 mg KOH/g, from 70 to 100 mg KOH/g, from 80 to 250 mg KOH/g, from 80 to 240 mg KOH/g, from 80 to 230 mg KOH/g, from 80 to 220 mg KOH/g, from 80 to 210 mg KOH/g, from 80 to 200 mg KOH/g, from 80 to 190 mg KOH/g, from 80 to 180 mg KOH/g, from 80 to 170 mg KOH/g, from 80 to 150 mg KOH/g, from 80 to 140 mg KOH/g, from 80 to 130 mg KOH/g, from 80 to 110 mg KOH/g, from 80 to 100 mg KOH/g, from 90 to 250 mg KOH/g, from 90 to 240 mg KOH/g, from 90 to 230 mg KOH/g, from 90 to 220 mg KOH/g, from 90 to 210 mg KOH/g, from 90 to 200 mg KOH/g, from 90 to 190 mg KOH/g, from 90 to 180 mg KOH/g, from 90 to 170 mg KOH/g, from 90 to 150 mg KOH/g, from 90 to 140 mg KOH/g, from 90 to 130 mg KOH/g, from 90 to 110 mg KOH/g, and from 90 to 100 mg KOH/g. Other ranges are also contemplated.

In many embodiments, the acrylic resin has a number average molecular weight (Mn) of 1000 to 7000. The number average molecular weight (Mn) may be measured by NMR or GPC referencing ASTM D5296-19. In other embodiments, Mn of the acrylic resin described herein can, for example, range from 1000 to 6500, from 1000 to 6000, from 1000 to 5500, from 1000 to 5000, from 1000 to 4000, from 1500 to 7000, from 1500 to 6500, from 1500 to 6000, from 1500 to 5500, from 1500 to 5000, from 1500 to 4000, from 2000 to 7000, from 2000 to 6500, from 2000 to 6000, from 2000 to 5500, from 2000 to 5000, from 2000 to 4000, from 2500 to 7000, from 2500 to 6500, from 2500 to 6000, from 2500 to 5500, from 2500 to 5000, from 2500 to 4000, from 3000 to 7000, from 3000 to 6500, from 3000 to 6000, from 3000 to 5500, from 3000 to 5000, and from 3000 to 4000. In one particular embodiment, the acrylic resin has a Mn from 2000 to 6000. Other Mn values are also contemplated.

In many embodiments, the Tg of the acrylic resin is between 10° C. and 90° C. The Tg described herein is measured by Differential Scanning calorimetry (DSC) using ASTM D6604-00. In other embodiments, the acrylic resin described herein can, for example, range from a Tg of 10° C. to 85° C., 10° C. to 80° C., 10° C. to 75° C., 10° C. to 70° C., 10° C. to 65° C., 10° C. to 60° C., 15° C. and 90° C., 15° C. to 85° C., 15° C. to 80° C., 15° C. to 75° C., 15° C. to 70° C., 15° C. to 65° C., 15° C. to 60° C., 20° C. to 90° C., 20° C. to 85° C., 20° C. to 80° C., 20° C. to 75° C., 20° C. to 70° C., 20° C. to 65° C., 20° C. to 60° C., 25° C. and 90° C., 25° C. to 85° C., 25° C. to 80° C., 25° C. to 75° C., 25° C. to 20° C., 25° C. to 65° C., 25° C. to 60° C., 30° C. to 85° C., 30° C. to 80° C., 30° C. to 75° C., 30° C. to 70° C., 30° C. to 65° C., 30° C. to 60° C., 35° C. and 90° C., 35° C. to 85° C., 35° C. to 80° C., 35° C. to 75° C., 35° C. to 70° C., 35° C. to 65° C., 35° C. to 60° C., 40° C. and 90° C., 40° C. to 85° C., 40° C. to 80° C., 40° C. to 75° C., 40° C. to 70° C., 40° C. to 65° C., 40° C. to 60° C., 45° C. and 90° C., 45° C. to 85° C., 45° C. to 80° C., 45° C. to 75° C., 45° C. to 70° C., 45° C. to 65° C., 45° C. to 60° C., 50° C. and 90° C., 50° C. to 85° C., 50° C. to 80° C., 50° C. to 75° C., 50° C. to 70° C., 50° C. to 65° C., 50° C. to 60° C., 55° C. and 90° C., 55° C. to 85° C., 55° C. to 80° C., 55° C. to 75° C., 55° C. to 70° C., 55° C. to 65° C., and 55° C. to 60° C. In one embodiment, the Tg of the acrylic resin is between 40° C. and 80° C.

In many embodiments, the acrylic resin described herein comprises at least one epoxy silane oligomer, wherein the epoxy silane oligomer is grafted onto at least one hydroxy group of the acrylic resin and at least one epoxy silane oligomer is 0.1% to 30% by weight of the acrylic resin. In other embodiments, the epoxy silane oligomer described herein can, for example, range from 0.1% to 25% by weight, from 0.1% to 20% by weight, from 0.1% to 15% by weight, from 0.1% to 10% by weight, from 0.1% to 5% by weight, from 0.5% to 30% by weight, from 0.5% to 25% by weight, from 0.5% to 20% by weight, from 0.5% to 15% by weight, from 0.5% to 10% by weight, from 0.5% to 5% by weight, from 1% to 30% by weight, from 1% to 25% by weight, from 1% to 20% by weight, from 1% to 15% by weight, from 1% to 10% by weight, from 1% to 5% by weight, from 2% to 30% by weight, from 2% to 25% by weight, from 2% to 20% by weight, from 2% to 15% by weight, from 2% to 10% by weight, from 2% to 5% by weight, from 5% to 30% by weight, from 5% to 25% by weight, from 5% to 20% by weight, from 5% to 15% by weight, from 5% to 10% by weight, from 7% to 30% by weight, from 7% to 25% by weight, from 7% to 20% by weight, from 7% to 15% by weight, from 7% to 10% by weight, from 10% to 30% by weight, from 10% to 25% by weight, from 10% to 20% by weight, from 10% to 15% by weight, from 15% to 30% by weight, from 15% to 25% by weight, from 15% to 20% by weight, from 20% to 30% by weight, and from 20% to 25% by weight. Other ranges are also contemplated.

In many embodiments, the at least one epoxy silane oligomer has a number average molecular weight (Mn) ranging from 400 to 2000. The number average molecular weight (Mn) may be measured by NMR or GPC referencing ASTM D5296-19. In other embodiments, the epoxy silane oligomer described herein can, for example, range from 400 to 1800, from 400 to 1500, from 400 to 1300, from 400 to 1200, from 400 to 1000, from 500 to 2000, from 500 to 1800, from 500 to 1500, from 500 to 1300, from 500 to 1200, from 500 to 1000, from 600 to 2000, from 600 to 1800, from 600 to 1500, from 600 to 1300, from 600 to 1200, from 600 to 1000, from 700 to 2000, from 700 to 1800, from 700 to 1500, from 700 to 1300, from 700 to 1200, from 700 to 1000, from 800 to 2000, from 800 to 1800, from 800 to 1500, from 800 to 1300, from 800 to 1200, from 800 to 1000, from 1000 to 2000, from 1000 to 1800, from 1000 to 1500, from 1000 to 1300, from 1000 to 1200, from 1200 to 2000, from 1200 to 1800, from 1200 to 1500, from 1300 to 2000, from 1300 to 1800, from 1400 to 2000, and from 1400 to 1800. Other ranges are also contemplated.

In many embodiments, the ureido functionality of the acrylic resin comprises a ureido monomer with a (meth)acrylate group and a cyclic ureido group. In some embodiments, the ureido monomer comprises Structure I, Structure II, or combinations thereof.

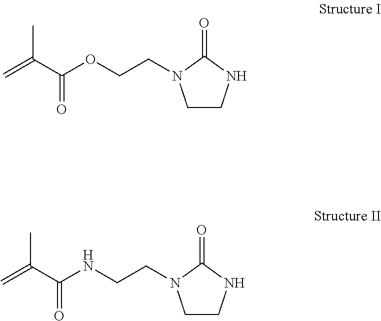

In some embodiments, the ureido monomer is 0.1% to 10.0% by weight monomer based on the total monomer weight of the acrylic resin. In another embodiment, the ureido monomer is 1.0% to 8.0% by weight monomer based on the total monomer weight of the acrylic resin. In yet another embodiment, the ureido monomer is 1.0% to 5.0% by weight monomer based on the total monomer weight of the acrylic resin. In other embodiments, the ureido monomer described herein can, for example, range from 0.1% to 9.0% by weight, from 0.1% to 8.0% by weight, 0.1% to 7.0% by weight, from 0.1% to 6.0% by weight, from 0.1% to 5.0% by weight, from 0.1% to 4.0% by weight, from 0.5% to 10.0% by weight, from 0.5% to 9.0% by weight, from 0.5% to 8.0% by weight, from 0.5% to 7.0% by weight, from 0.5% to 6.0% by weight, from 0.5% to 5.0% by weight, from 0.5% to 4.0% by weight, from 1.0% to 10.0% by weight, from 1.0% to 9.0% by weight, from 1.0% to 8.0% by weight, from 1.0% to 7.0% by weight, from 1.0% to 6.0% by weight, from 1.0% to 4.0% by weight, from 1.5% to 10.0% by weight, from 1.5% to 9.0% by weight, from 1.5% to 8.0% by weight, from 1.5% to 7.0% by weight, from 1.5% to 6.0% by weight, from 1.5% to 5.0% by weight, from 1.5% to 4.0% by weight, from 2.0% to 10.0% by weight, from 2.0% to 9.0% by weight, from 2.0% to 8.0% by weight, from 2.0% to 7.0% by weight, from 2.0% to 6.0% by weight, from 2.0% to 5.0% by weight, from 2.0% to 4.0% by weight, from 2.5% to 10.0% by weight, from 2.5% to 9.0% by weight, from 2.5% to 8.0% by weight, from 2.5% to 7.0% by weight, from 2.5% to 6.0% by weight, from 2.5% to 5.0% by weight, from 2.5% to 4.0% by weight, from 3.0% to 10.0% by weight, from 3.0% to 9.0% by weight, from 3.0% to 8.0% by weight, from 3.0% to 7.0% by weight, from 3.0% to 6.0% by weight, from 3.0% to 5.0% by weight, and from 3.0% to 4.0% by weight. Other ranges are contemplated.

In many embodiments, the epoxy silane monomer is 0.1% to 10.0% by weight monomer based on the total monomer weight. In another embodiment, the epoxy silane monomer is 0.1% to 8.0% by weight monomer based on the total monomer weight of the acrylic resin. In some embodiments, the epoxy silane monomer is 0.5% to 6.0% by weight monomer based on the total monomer weight. In other embodiments, the epoxy silane monomer described herein can, for example, range from 0.1% to 9.0% by weight, from 0.1% to 7.0% by weight, from 0.1% to 6.0% by weight, from 0.1% to 5.0% by weight, from 0.1% to 4.0% by weight, from 0.5% to 10.0% by weight, from 0.5% to 9.0% by weight, from 0.5% to 8.0% by weight, from 0.5% to 7.0% by weight, from 0.5% to 5.0% by weight, from 0.5% to 4.0% by weight, from 1.0% to 10.0% by weight, from 1.0% to 9.0% by weight, from 1.0% to 8.0% by weight, from 1.0% to 7.0% by weight, from 1.0% to 6.0% by weight, from 1.0% to 5.0% by weight, from 1.0% to 4.0% by weight, from 1.5% to 10.0% by weight, from 1.5% to 9.0% by weight, from 1.5% to 8.0% by weight, from 1.5% to 7.0% by weight, from 1.5% to 6.0% by weight, from 1.5% to 5.0% by weight, from 1.5% to 4.0% by weight, from 2.0% to 10.0% by weight, from 2.0% to 9.0% by weight, from 2.0% to 8.0% by weight, from 2.0% to 7.0% by weight, from 2.0% to 6.0% by weight, from 2.0% to 5.0% by weight, from 2.0% to 4.0% by weight, from 2.5% to 10.0% by weight, from 2.5% to 9.0% by weight, from 2.5% to 8.0% by weight, from 2.5% to 7.0% by weight, from 2.5% to 6.0% by weight, from 2.5% to 5.0% by weight, from 2.5% to 4.0% by weight, from 3.0% to 10.0% by weight, from 3.0% to 9.0% by weight, from 3.0% to 8.0% by weight, from 3.0% to 7.0% by weight, from 3.0% to 6.0% by weight, from 3.0% to 5.0% by weight, and from 3.0% to 4.0% by weight. Other ranges are contemplated.

In many embodiments, at least one acrylic resin comprises styrene, methyl methacrylate, methacrylic acid, hydroxyethyl acrylate, acetoacetoxyethyl methacrylate, butyl acrylate, butyl methacrylate, methyl (meth)acrylate, ethyl (meth)acrylate, propyl (meth)acrylate, n-/i-/t-butyl (meth)acrylate, 2-ethylhexyl (meth)acrylate, lauryl (meth)acrylate, stearyl (meth)acrylate, hydroxyethyl methacrylate, hydroxypropyl (meth)acrylate, hydroxybutyl (meth)acrylate, isobornyl (meth)acrylate, glycidyl methacrylate, 4-hydroxybutyl acrylate glycidyl ether, 2-(acetoacetoxy)ethyl methacrylate, lauryl methacrylate, stearyl methacrylate, cyclohexyl methacrylate, diacetone acrylamide, acrylamide, methacrylamide, methylol (meth)acrylamide, styrene, a-methyl styrene, vinyl toluene, vinyl acetate, vinyl propionate, allyl methacrylate, or combinations thereof. Other acrylic resins are also contemplated.

In many embodiments, the acrylic resin described herein may comprise at least one silane epoxy oligomer. The silane epoxy functional oligomer may provide improved adhesion and crosslinking. In one embodiment, the silane epoxy oligomer may comprise 3-(2,3-epoxypropoxypropyl)triethoxysilane. In another embodiment, the silane epoxy oligomer may comprise 3-(2,3-epoxypropoxypropyl) methyldiethoxysilane, In another embodiment, the silane epoxy oligomer may comprise 2-(3,4-epoxycyclohexyl)ethyltrimethoxysilane. In yet another embodiment, the silane epoxy oligomer may comprise 3-glycidyl-oxypropyl-trimethoxy-silane. In still another embodiment, the silane epoxy oligomer comprises 3-glycidyl-oxypropyl-methyldimethoxy-silane. In yet another embodiment, at least one silane epoxy oligomer comprises 3-(2,3-epoxypropoxypropyl)triethoxysilane, 3-(2,3-epoxypropoxypropyl) methyldiethoxysilane, 2-(3,4-epoxycyclohexyl)ethyltrimethoxysilane, 3-glycidyl-oxypropyl-trimethoxy-silane, 3-glycidyl-oxypropyl-methyldimethoxy-silane, or combinations thereof. Other silane epoxy oligomers are contemplated. In one embodiment, the silane epoxy oligomer may be functionalized. In some embodiments, an epoxy value (mol/100 g epoxy) of the silane epoxy oligomer described herein is 0.20 to 1.00 as measured by ASTM D1652-11. In other embodiments, the epoxy value of the silane epoxy oligomer as measured by ASTM D1652-11 can, for example, range from 0.20 to 0.95, from 0.20 to 0.90, from 0.20 to 0.85, 0.20 to 0.80, from 0.20 to 0.75, from 0.20 to 0.70, 0.20 to 0.65, from 0.20 to 0.60, 0.20 to 0.55, from 0.20 to 0.50, from 0.20 to 0.45, from 0.20 to 0.40, from 0.20 to 0.35, from 0.20 to 0.30, from 0.30 to 1.00, from 0.30 to 0.95, from 0.30 to 0.90, from 0.30 to 0.85, from 0.30 to 0.80, from 0.30 to 0.75, from 0.30 to 0.70, 0.30 to 0.65, from 0.30 to 0.60, from 0.30 to 0.55, from 0.30 to 0.50, from 0.30 to 0.45, from 0.35 to 1.00, from 0.35 to 0.95, from 0.35 to 0.90, from 0.35 to 0.85, from 0.35 to 0.80, from 0.35 to 0.75, from 0.35 to 0.70, from 0.35 to 0.65, from 0.35 to 0.60, from 0.35 to 0.60, from 0.35 to 0.55, from 0.35 to 0.50, from 0.40 to 1.00, from 0.40 to 0.95, from 0.40 to 0.90, from 0.40 to 0.85, from 0.40 to 0.80, from 0.40 to 0.75, from 0.40 to 0.70, 0.40 to 0.65, from 0.40 to 0.60, from 0.40 to 0.55, from 0.40 to 0.50, from 0.45 to 1.00, from 0.45 to 0.95, from 0.45 to 0.90, from 0.45 to 0.85, from 0.45 to 0.80, from 0.45 to 0.75, from 0.45 to 0.70, 0.45 to 0.65, from 0.45 to 0.60, from 0.45 to 0.55, and from 0.45 to 0.50.

In some embodiments, at least one acid group of the at least one acrylic resin is at least partially grafted to at least one epoxy silane oligomer. It is speculated that at least one hydroxy group of the acrylic resin is grafted or partially grafted to at least one epoxy silane oligomer and this grafting may provide unexpected benefits.

Further, at least one acid group may have an acid value (as calculated in mg KOH). Not to be bound by theory, the acid value may be modified such that the coating properties may achieve desired properties. In some embodiments, the acid value (in mg KOH) may range from 2 to 30. In other embodiments, the acid value described herein can, for example, range from 2 to 25, 2 to 22, 2 to 20, 2 to 18, 2 to 15, 2 to 13, 2 to 10, 2 to 8, 2 to 5, 5 to 30, 5 to 25, 5 to 22, 5 to 20, 5 to 18, 5 to 15, 5 to 13, 5 to 10, 5 to 8, 7 to 30, 7 to 25, 7 to 22, 7 to 20, 7 to 18, 7 to 15, 7 to 13, 7 to 10, 10 to 30, 10 to 25, 10 to 22, 10 to 20, 10 to 18, 10 to 15, 10 to 13, 12 to 30, 12 to 25, 12 to 22, 12 to 20, 12 to 18, 12 to 15, 15 to 30, 15 to 25, 15 to 22, 15 to 20, and 15 to 18. Other ranges are also contemplated.

Also disclosed is a method of preparing the acrylic resin described herein. The acrylic resin comprises at least one epoxy silane oligomer, wherein the epoxy silane oligomer is grafted onto at least one hydroxy group of the acrylic resin; wherein the at least one hydroxy group of the acrylic resin has at least one ureido functionality; and wherein the at least one hydroxy group of the acrylic resin has at least one acid group.

Further provided is a two-component coating system comprising: 1) a first part comprising at least one isocyanate; and 2) a second part comprising the acrylic resin disclosed herein. The acrylic resin comprises at least one hydroxy group with at least one epoxy silane oligomer, wherein the at least one hydroxy group of the acrylic resin has a ureido functionality.

In the two-component system, the first part may comprise at least one isocyanate such that a polyurethane is formed when the isocyanate is combined with the second component containing the hydroxy groups described herein. For the two-component coating system, the isocyanate may act as a hardener for the system. The isocyanate functional material may be selected from mono-, di-, tri-, and poly-functional isocyanates. Further, the isocyanate functional material may be (cyclo)aliphatic, araliphatic or aromatic in nature. Representative isocyanates will have two or more isocyanate groups per molecule and may include the aliphatic compounds such as ethylene diisocyanate, trimethylene diisocyanate, tetramethylene diisocyanate, pentamethylene diisocyanate, hexamethylene diisocyanate, 1,2-propylene diisocyanate, 1,2-butylene diisocyanate, 2,3-butylene diisocyanate, 1,3-butylene diisocyanate, ethylidene diisocyanate and butylidene diisocyanate; the cycloalkylene compounds such as 3-isocyanatomethyl-3,5,5-trimethylcyclohexylisocyanate, and 1,3-cyclopentane diisocyanate, 1,3-cyclohexane diisocyanate, and 1,2-cyclohexane diisocyanate; the aromatic compounds such as m-phenylene diisocyanate, p-phenylene diisocyanate, 4,4′-diphenyl diisocyanate, 1,5-naphthalene diisocyanate and 1,4-naphthalene diisocyanate; the aliphatic-aromatic compounds such as 4,4′-diphenylene methane diisocyanate, 2,4- or 2,6-toluene diisocyanate, or mixtures thereof, 4,4′-toluidine diisocyanate, and 1,4-xylylene diisocyanate; the nuclear substituted aromatic compounds such as dianisidine diisocyanate, 4,4′-diphenylether diisocyanate and chlorodiphenylene diisocyanate; the triisocyanates such as triphenyl methane-4,4′,4″-triisocyanate, 1,3,5-triisocyanate benzene and 2,4,6-triisocyanate toluene; and the tetraisocyanates such as 4,4′-diphenyl-dimethyl methane-2,2′-5,5′-tetraisocyanate; the polymerized polyisocyanates such as toluene diisocyanate dimers and trimers, and other various polyisocyanates containing biuret, urethane, and/or allophanate linkages. Further, the isocyanates may be hydrophobic organic polyisocyanates including but not limited to: 1,6-diisocyanatohexane, isophorone diisocyanate, diphenyl methane-diisocyanate, 4,4′-bis(isocyanatocyclohexyl) methane, 1,4-diisocyanatobutane, 1,5-diisocyanato-2,2-dimethyl pentane, 2,2,4-trimethyl-1,6-diisocyanatohexane, 1,10-diisocyanatodecane, 4,4-diisocyanato-cyclohexane, 2,4-hexahydrotoluene diisocyanate, 2,6-hexahydrotoluene diisocyanate, norbornane diisocyanate, 1,3-xylylene diisocyanate, 1,4-xylylene diisocyanate, 1-isocyanato-3-(isocyanato methyl)-1-methyl cyclohexane, m-α,α-α′,α′-tetramethyl xylylene diisocyanate, or combinations thereof. In some embodiments, the hydrophobic polyisocyanate may include biuret, urethane, uretdione, and isocyanurate derivatives of the above-mentioned compounds Normally, these products are liquid at ambient temperature and commercially available in a wide range. Particularly preferred isocyanate curing agents are triisocyanates and adducts. Examples thereof are 1,8-diisocyanato-4-(isocyanatomethyl) octane, the adduct of 3 moles of toluene diisocyanate to 1 mole of trimethylol propane, the isocyanurate trimer of 1,6-diisocyanatohexane, the isocyanurate trimer of isophorone diisocyanate, the uretdione dimer of 1,6-diisocyanatohexane, the biuret trimer of 1,6-diisocyanatohexane, the adduct of 3 moles of m-α,α-α′,α′-tetramethyl xylene diisocyanate to 1 mole of trimethylol propane, and combinations thereof. Optionally, the isocyanate may comprise an organic hydrophilic polyisocyanate compound substituted with non-ionic groups, such as the above-mentioned C₁-C₄ alkoxy polyalkylene oxide groups. In some embodiments, 30 wt. % of non-ionic groups may be present on total solid polyisocyanate compound, i.e. organic hydrophobic and hydrophilic polyisocyanate. In other embodiments, 20 wt. % of non-ionic groups may be present on total solid polyisocyanate compound. In other embodiments, 15 wt % of non-ionic groups may be present on total solid polyisocyanate compound. Combinations of mono-, di-, tri-, and multifunctional isocyanates are also contemplated. The isocyanates may be waterborne, solvent-borne, or a combination thereof.

In some approaches, the isocyanate functional material may be packaged separately from the component including the above-described polymer systems and other optional components. The curing component, including the isocyanate functional material, may further include one or more catalysts, solvents, non-reactive (with the isocyanate) additives, and combinations thereof as needed for a particular application.

The isocyanate functional material may be mixed into the second part comprising the acrylic resin described herein by any suitable technique. However, simply stirring is usually sufficient. Sometimes it may be useful to dilute the isocyanate functional material with an organic solvent like butyl acetate or 1-methoxy-2-propyl acetate to reduce the viscosity.

In many embodiments, the mix ratio for isocyanate (NCO) and polyols (OH) may be calculated to maximize performance of the two-component coating system described herein. Both isocyanate (NCO) and polyols (OH) equivalent weights are calculated separately.

The equivalent weight (eq. wt.) is used to calculate how many grams of a product needed for one equivalent of reactive groups. For an isocyanate, the reactive group is —N═C═O (“NCO”), its concentration is measured by weight percent NCO) and calculated as follows: The isocyanate equivalent weight (NCO EW) is calculated by 4202 being divided by the hydroxyl value:

$$Isocyanate Equivalent weight ( g / equivalent ) = \frac{4202}{\% NCO}$$

Similarly, the reactive group for a polyol is —O—H (OH) and a hydroxyl value may be calculated. The hydroxyl value is determined using ASTM E222-65T. The hydroxyl equivalent weight (OH EW) is calculated by 56100 being divided by the hydroxyl value:

$$Hydroxyl Equivalent weight ( g / equivalent ) = \frac{56100}{Hydroxyl value}$$

The isocyanate equivalent weight and the polyol equivalent weights calculated as shown above provide the equivalent weights for both the NCO and OH values used to describe the NCO/OH ratio ranges. In many embodiments, an NCO/OH ratio (also referred to as isocyanate index) ranges from 1.01:1.00 to 1.30:1.00. In other embodiments, the NCO/OH ratio ranges from 1.02:1.00 to 1.20:1.00. In other embodiments, the NCO/OH ratio can, for example, range from 1.01.1.00 to 1.25:1.00, 1.01:1.00 to 1.20:1.00, 1.01:1.00 to 1.15:1.00, 1.01:1.00 to 1.10:1.00, 1.02:1.00 to 1.30:1.00, 1.02:1.00 to 1.25:1.00, 1.02:1.00 to 1.15:1.00, 1.02:1.00 to 1.10:1.00, 1.03:1.00 to 1.30:1.00, 1.03:1.00 to 1.25:1.00, 1.03:1.00 to 1.20:1.00, 1.03:1.00 to 1.15:1.00, 1.03:1.00 to 1.10:1.00, 1.05:1.00 to 1.30:1.00, 1.05:1.00 to 1.25:1.00, 1.05:1.00 to 1.20:1.00, 1.05:1.00 to 1.15:1.00, 1.05:1.00 to 1.10:1.00, 1.07:1.00 to 1.30:1.00, 1.07:1.00 to 1.25:1.00, 1.07:1.00 to 1.20:1.00, 1.07:1.00 to 1.15:1.00, and 1.07:1.00 to 1.10:1.00.

Additionally in many embodiments, the two-component coating system described herein further comprises at least one: thickener, defoamer, dispersant, wetting agent, flow agent, catalyst, solvent, anti-sagging agent, anti-corrosion agent, anti-popping agent, adhesion promoter, pigment, filler, hardener, or combinations thereof.

Further, the two-component coating system described herein may be applied directly to a surface of a substrate. In many embodiments, the substrate comprises wood, metal, glass, plastic, paper, leather, fabric, ceramic, or any combination thereof. Other substrates are also contemplated.

Also disclosed is a method of preparing the two-component coating system disclosed herein. The two-component coating system comprises: 1) a first part comprising at least one isocyanate; and 2) a second part comprising the acrylic resin, wherein the acrylic resin comprises at least one hydroxy group with at least one epoxy silane oligomer and wherein the at least one hydroxy group of the acrylic resin has a ureido functionality.

### EXAMPLES AND TESTING

### Example 1 Acrylic Resin with Ureido Group Only

1345 g of n-butyl acetate was charge to a clean 5000 mL flask equipped with mechanic agitator, N2 inflow, and reflux condenser. The flask was blanked with N2 and heated 115° C. Load all acrylic monomers (methyl methacrylate: 163.8 g; n-butyl methacrylate: 403.2 g; hydroxyethyl methacrylate 588 g; isobornyl methacrylate: 672 g; Methyl methacrylate: 189 g; N-(2-Methacryloyloxyethyl) ethylene urea (MEEU): 63 g; methacrylic acid: 21 g) into a tank and initiator t-amyl peroctoate: 132.3 g in another tank. At 115° C., the monomer mixture and the initiator were fed into flask over 4.0 hours. After feeding, the reaction was hold for 30 min. Then, add 6.3 g t-amyl peroctoate in one shot and hold for 40 minutes. After holding, add another 6.3 g t-amyl peroctoate and hold for 60 minutes Cool the reaction to 90° C. or below. Add 40 g of n-butyl acetate to adjust the NVM of the resin. Filter the resin into a metal can. The non-volatile material of the resin solution is 61.0% with the Gardner viscosity of Z3⁺.

### Example 2 Acrylic Resin Containing Ureido Group and Epoxy Silane Oligomer

1295 g of n-butyl acetate was charge to a clean 5000 mL flask equipped with mechanic agitator, N2 inflow, and reflux condenser. The flask was blanked with N2 and heated 115° C. Load all acrylic monomers (methyl methacrylate: 163.8 g; n-butyl methacrylate: 403.2 g; hydroxyethyl methacrylate 588 g; isobornyl methacrylate: 672 g; Methyl methacrylate: 189 g; MEEU: 63 g; methacrylic acid: 21 g) into a tank and initiator t-amyl peroctoate. 132.3 g in another tank. At 115° C., the monomer mixture and the initiator were fed into flask over 4.0 hours. After feeding, the reaction was hold for 30 min. Then, add 6.3 g t-amyl peroctoate in one shot and hold for 40 minutes. After holding, add another 6.3 g t-amyl peroctoate and hold for 60 minutes. Cool the reaction to 90° C. or below. Add 42 g of epoxy functional silane oligomer and 50 g of n-butyl acetate mixture. Keep mixing for 30 minutes. Adjust the NVM with 50 g of n-butyl acetate. Then filter the resin product into a metal can. The non-volatile material of the resin solution is 60.7% with the Gardner viscosity of Z3⁺.

### Example 3 Acrylic Resin Containing Ureido Group and Epoxy Silane Oligomer

1235 g of n-butyl acetate was charge to a clean 5000 mL flask equipped with mechanic agitator, N2 inflow, and reflux condenser. The flask was blanked with N2 and heated 115° C. Load all acrylic monomers (methyl methacrylate: 156 g; n-butyl methacrylate: 384 g; hydroxyethyl methacrylate 560 g; isobornyl methacrylate: 640 g; Methyl methacrylate: 180 g; MEEU: 60 g; methacrylic acid: 20 g) into a tank and initiator t-amyl peroctoate: 126 g in another tank. At 115° C., the monomer mixture and the initiator were fed into flask over 4.0 hours. After feeding, the reaction was hold for 30 min. Then, add 6.0 g t-amyl peroctoate in one shot and hold for 40 minutes. After holding, add another 6.0 g t-amyl peroctoate and hold for 60 minutes. Cool the reaction to 90° C. or below. Add 80 g of epoxy functional silane oligomer and 80 g of n-butyl acetate mixture. Keep mixing for 30 minutes. Adjust the NVM with 40 g of n-butyl acetate. Then filter the resin product into a metal can. The non-volatile material of the resin solution is 61.2% with the Gardner viscosity of Z1-Z2.

### Example 4 Paint Formulation

The paints were composed of Part A, Part B, and Part C as provided below in Tables 1-3. Part A or the base were made from the acrylic resins prepared according to example 1 and 3 above. 31 g of resin and 5.811 g of xylene were added into a metal pint can. All other coating ingredients in part A as shown in the following table 1 were dispersed into resin solution in sequence. The composition of Part B or hardener and Part C or thinner was listed in Table 2 and Table 3, respectively. The mixing ratio of part A: part B: part C in the ready-to-spray paint is 6:1+30% in volume.

TABLE 1
Part A

| | Weight (g) | | |
|---|---|---|---|
| | Formula | Formula | Formula |
| Ingredients | #1 | #2 | #3 |
| Resin example 1 | 31.00 | | |
| Resin example 2 | | 31.00 | |
| Resin example 3 | | | 31.00 |
| xylene | 5.811 | 5.811 | 5.811 |
| Polyamine amide salt | 0.774 | 0.774 | 0.774 |
| Organophilic phyllosilicate | 0.774 | 0.774 | 0.774 |
| Zinc Aluminum phosphate | 9.277 | 9.277 | 9.277 |
| Titanium dioxide | 6.626 | 6.626 | 6.626 |
| Iron oxide black pigment | 2.12 | 2.12 | 2.12 |
| nBA (butyl alcohol) | 4.162 | 4.162 | 4.162 |
| Talc | 14.842 | 14.842 | 14.842 |
| Barium sulphate | 21.203 | 21.203 | 21.203 |
| Butyl Acrylate | 1.438 | 1.438 | 1.438 |
| xylene | 1.74 | 1.74 | 1.74 |
| Polyether modified | 0.113 | 0.113 | 0.113 |
| polysiloxane | | | |
| Dioctyltin dilaurate (DOTL) | 0.12 | 0.12 | 0.12 |

TABLE 2
Part B

| | Weight |
|---|---|
| Ingredients | (g) |
| nBA (butyl alcohol) | 24.8 |
| Dioctyltin dilaurate (DOTL) | 0.2 |
| Aliphatic polyisocyanate | 65.0 |
| Cycloaliphatic Polyisocyanate | 10.0 |
| isophorone diisocyanate (IPDI) | |
| total | 100 |

TABLE 3
Part C

| | Weight |
|---|---|
| Ingredients | (g) |
| nBA | 49.7 |
| (butyl alcohol) | |
| Xylene | 50.3 |
| total | 100 |

Coatings were prepared by spraying to a dry layer thickness around 80 microns to a steel plate sanded with P180 sanding paper and degreased by solvent in two coats. The flash-off time between the coats at 20° C. was 7 minutes. The direct to steel adhesion was tested using DIN EN ISO 2409 after 7 days by GT cross-cut test with 2 mm between the lines. The DTM adhesion results showed in % delamination after testing was listed in Table 4 below. The results indicated that the first comparison examples containing ureido group only did not have any adhesion over substrate without wash primer. However, the last two paint samples based on this invention showed equal or better adhesion than that with wash primer.

TABLE 4

| | Contains | % delamination | | |
|---|---|---|---|---|
| Paint | Wash | Formula | Formula | Formula |
| sample | Primer? | #1 | #2 | #3 |
| Formula #1 | no | 100 | 100 | 100 |
| | yes | 6 | <5 | 10 |
| Formula #2 | no | <10 | 12 | <5 |
| | yes | 10-15 | 20 | 10 |
| Formula #3 | no | 10-15 | 10 | <5 |
| | yes | 20-25 | 20-25 | 10 |

In some embodiments, additional adhesion promoters could be incorporated into formulas containing the acrylic resin described herein to further improve the adhesion of the invented resins over different substrates. One new formula was made by adding 1-5% of adhesion promoter in the Formula #2 (shown in Table 4 above). The DTM adhesion results listed in Table 5 below showed that the resin system described herein with additional adhesion promoters offered improved adhesion over cold roll steel and aluminum.

TABLE 5

| | | % |
|---|---|---|
| Substrates | Coat system | delamination |
| Cold Roll Steel | Primer only | <5 |
| | Full system | <5 |
| Aluminum | Primer only | 10-25 |
| | Full system | 5-15 |

### EMBODIMENTS

The following embodiments are contemplated. All combinations of features and embodiments are contemplated.
Embodiment 1: An acrylic resin comprising: at least one epoxy silane oligomer, wherein the epoxy silane oligomer is grafted onto at least one hydroxy group of the acrylic resin; wherein the at least one hydroxy group of the acrylic resin has at least one ureido functionality; and wherein the at least one hydroxy group of the acrylic resin has at least one acid group.
Embodiment 2: An embodiment of Embodiment 1, wherein the acrylic resin has a hydroxyl number of 50 to 250 mg KOH/g as measured by ASTM D6342-12.
Embodiment 3: An embodiment of any of Embodiments 1-2, wherein the acrylic resin has a Mn of 1000 to 7000 as measured by ASTM D5296-19.
Embodiment 4: An embodiment of any of Embodiments 1-3, wherein the Tg of the acrylic resin is between 10° C. and 90° C. as measured by Differential Scanning calorimetry (DSC) using ASTM D6604-00.
Embodiment 5: An embodiment of any of Embodiments 1-4, wherein the at least one epoxy silane oligomer is 0.1% to 30% by weight of the acrylic resin.
Embodiment 6: An embodiment of any of Embodiments 1-5, wherein the at least one epoxy silane oligomer has a number average molecular weight (Mn) of 400 to 2000 as measured by NMR or GPC referencing ASTM DS296-19.
Embodiment 7: An embodiment of any of Embodiments 1-6, wherein the at least one epoxy silane oligomer has an epoxy value (mol/100 g epoxy) of 0.20 to 1.00 as measured by ASTM D1652-11.
Embodiment 8: An embodiment of any of Embodiments 1-7, wherein the ureido functionality comprises a ureido monomer with a (meth)acrylate group and a cyclic ureido group.
Embodiment 9: An embodiment of Embodiment 8, wherein the ureido monomer comprises Structure I, Structure II, or combinations thereof.

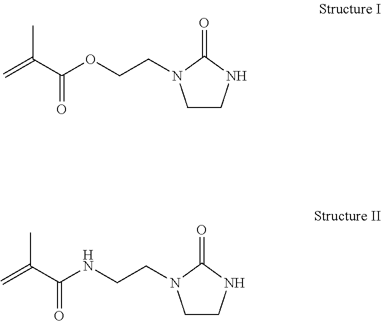

Embodiment 10: An embodiment of any of Embodiments 8-9, wherein the ureido monomer is 0.1% to 10.0% by weight monomer based on the total monomer weight.
Embodiment 11: An embodiment of any of Embodiments 1-10, wherein the epoxy silane monomer is 0.1% to 10.0% by weight monomer based on the total monomer weight.
Embodiment 12: An embodiment of any of Embodiments 1-11, wherein at least one acrylic resin comprises styrene, methyl methacrylate, methacrylic acid, hydroxyethyl acrylate, acetoacetoxyethyl methacrylate, butyl acrylate, butyl methacrylate, methyl (meth)acrylate, ethyl (meth)acrylate, propyl (meth)acrylate, n-/i-/t-butyl (meth)acrylate, 2-ethylhexyl (meth)acrylate, lauryl (meth)acrylate, stearyl (meth)acrylate, hydroxyethyl methacrylate, hydroxypropyl (meth)acrylate, hydroxybutyl (meth)acrylate, isobornyl (meth)acrylate, glycidyl methacrylate, 4-hydroxybutyl acrylate glycidyl ether, 2-(acetoacetoxy)ethyl methacrylate, lauryl methacrylate, stearyl methacrylate, cyclohexyl methacrylate, diacetone acrylamide, acrylamide, methacrylamide, methylol (meth)acrylamide, styrene, a-methyl styrene, vinyl toluene, vinyl acetate, vinyl propionate, allyl methacrylate, or combinations thereof.
Embodiment 13: An embodiment of any of Embodiments 1-12, wherein at least one acid group of the at least one acrylic resin is at least partially grafted to at least one epoxy silane oligomer.
Embodiment 14: An embodiment of any of Embodiments 1-13 wherein at least one silane epoxy oligomer comprises 3-(2,3-epoxypropoxypropyl)triethoxysilane, 3-(2,3-epoxypropoxypropyl) methyldiethoxysilane, 2-(3,4-epoxycyclohexyl)ethyltrimethoxysilane, 3-glycidyl-oxypropyl-trimethoxy-silane, 3-glycidyl-oxypropyl-methyldimethoxy-silane, or combinations thereof.
Embodiment 15: A method of preparing the acrylic resin of any of Embodiments 1-14.
Embodiment 16: A two-component coating system comprising: 1) a first part comprising at least one isocyanate; and 2) a second part comprising the acrylic resin of any of Embodiments 1-18.
Embodiment 17: An embodiment of Embodiment 16, wherein an NCO/OH ratio ranges from 1.01:1.00 to 1.30:1.00.
Embodiment 18: An embodiment of any of Embodiments 16-17 further comprising at least one: thickener, defoamer, dispersant, wetting agent, flow agent, catalyst, solvent, anti-sagging agent, anti-corrosion agent, anti-popping agent, adhesion promoter, pigment, filler, hardener, or combinations thereof.
Embodiment 19: An embodiment of any of Embodiments 16-18 applied directly to a surface of a substrate, wherein the substrate comprises wood, metal, glass, plastic, paper, leather, fabric, ceramic, or any combination thereof.
Embodiment 20: A method of preparing the two-component coating system of any of Embodiments 16-19.

What has been described above includes examples of the claimed subject matter. All details and any described modifications in connection with the Background and Detailed Description are within the spirit and scope of the claimed subject matter will be readily apparent to those of skill in the art. In addition, it should be understood that aspects of the claimed subject matter and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only and is not intended to limit the claimed subject matter, realizing that many further combinations and permutations of the claimed subject matter are possible. It is, of course, not possible to describe every conceivable combination of components or methodologies for purposes of describing the claimed subject matter, but one of ordinary skill in the art may recognize. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An acrylic resin comprising:
at least one epoxy silane oligomer,
wherein the epoxy silane oligomer is grafted onto at least one hydroxy group of the acrylic resin;
wherein the at least one hydroxy group of the acrylic resin has at least one ureido functionality; and
wherein the at least one hydroxy group of the acrylic resin has at least one acid group.

2. The acrylic resin of claim 1, wherein the acrylic resin has a hydroxyl number of 50 to 250 mg KOH/g as measured by ASTM D6342-12.

3. The acrylic resin of claim 1, wherein the acrylic resin has a Mn of 1000 to 7000 as measured by ASTM D5296-19.

4. The acrylic resin of claim 1, wherein the Tg of the acrylic resin is between 10° C. and 90° C. as measured by Differential Scanning calorimetry (DSC) using ASTM D6604-00.

5. The acrylic resin of claim 1, wherein the at least one epoxy silane oligomer is 0.1% to 30% by weight of the acrylic resin.

6. The acrylic resin of claim 1, wherein the at least one epoxy silane oligomer has a number average molecular weight (Mn) between 400 and 2000 as measured by the NMR or GPC referencing ASTM D5296-19.

7. The acrylic resin of claim 1, wherein the at least one epoxy silane oligomer has an epoxy value (mol/100 g epoxy) of 0.20 to 1.00 as measured by ASTM D1652-11.

8. The acrylic resin of claim 1, wherein the ureido functionality comprises a ureido monomer with a (meth)acrylate group and a cyclic ureido group.

9. The acrylic resin of claim 8, wherein the ureido monomer comprises Structure I, Structure II, or combinations thereof.

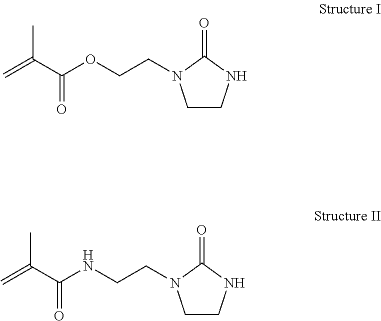

10. The acrylic resin of claim 8, wherein the ureido monomer is 0.1% to 10.0% by weight monomer based on the total monomer weight.

11. The acrylic resin of claim 1, wherein the epoxy silane monomer is 0.1% to 10.0% by weight monomer based on the total monomer weight.

12. The acrylic resin of claim 1, wherein at least one acrylic resin comprises styrene, methyl methacrylate, methacrylic acid, hydroxyethyl acrylate, acetoacetoxyethyl methacrylate, butyl acrylate, butyl methacrylate, methyl (meth)acrylate, ethyl (meth)acrylate, propyl (meth)acrylate, n-/i-/t-butyl (meth)acrylate, 2-ethylhexyl (meth)acrylate, lauryl (meth)acrylate, stearyl (meth)acrylate, hydroxyethyl methacrylate, hydroxypropyl (meth)acrylate, hydroxybutyl (meth)acrylate, isobornyl (meth)acrylate, glycidyl methacrylate, 4-hydroxybutyl acrylate glycidyl ether, 2-(acetoacetoxy)ethyl methacrylate, lauryl methacrylate, stearyl methacrylate, cyclohexyl methacrylate, diacetone acrylamide, acrylamide, methacrylamide, methylol (meth)acrylamide, styrene, a-methyl styrene, vinyl toluene, vinyl acetate, vinyl propionate, allyl methacrylate, or combinations thereof.

13. The acrylic resin of claim 1, wherein at least one acid group of the at least one acrylic resin is at least partially grafted to at least one epoxy silane oligomer.

14. The acrylic resin of claim 1 at least one silane epoxy oligomer comprises 3-(2,3-epoxypropoxypropyl)triethoxysilane, 3-(2,3-Epoxypropoxypropyl) methyldiethoxysilane, 2-(3,4-epoxycyclohexyl)ethyltrimethoxysilane, 3-glycidyl-oxypropyl-trimethoxy-silane, 3-glycidyl-oxypropyl-methyldimethoxy-silane, or combinations thereof.

15. A method of preparing the acrylic resin of claim 1.

16. A two-component urethane coating system comprising:
a first part comprising at least one isocyanate; and
a second part comprising the acrylic resin of claim 1.

17. The two-component coating system of claim 16, wherein an NCO/OH ratio ranges from 1.01:1.00 to 1.30:1.00.

18. The two-component coating system of claim 16 further comprising at least one: thickener, defoamer, dispersant, wetting agent, flow agent, catalyst, solvent, anti-sagging agent, anti-corrosion agent, anti-popping agent, adhesion promoter, pigment, filler, hardener, or combinations thereof.

19. The two-component coating system of claim 16 applied directly to a surface of a substrate, wherein the substrate comprises wood, metal, glass, plastic, paper, leather, fabric, ceramic, or any combination thereof.

20. A method of preparing the two-component coating system of claim 16.
